(19) United States
(12) Patent Application Publication
(10) Pub. No.: US 2025/0150194 A1
(43) Pub. Date: May 8, 2025

(54) SIGNAL PROCESSING METHOD, SIGNAL PROCESSING APPARATUS AND COMMUNICATION SYSTEM

(71) Applicant: NIPPON TELEGRAPH AND TELEPHONE CORPORATION, Tokyo (JP)

(72) Inventors: Masanori NAKAMURA, Musashino-shi (JP); Takayuki KOBAYASHI, Musashino-shi (JP); Fukutaro HAMAOKA, Musashino-shi, Tokyo (JP); Yutaka MIYAMOTO, Musashino-shi, Tokyo (JP)

(73) Assignee: Nippon Telegraph and Telephone Corporation, Tokyo (JP)

(21) Appl. No.: 18/832,739

(22) PCT Filed: Feb. 10, 2022
(86) PCT No.: PCT/JP2022/005448

§ 371 Date: Jul. 24, 2024

(51) Int. Cl. H04J 14/06

(52) U.S. Cl. CPC H04J 14/06

(57) ABSTRACT

A signal processing method of converting a real number component and an imaginary number component of each polarization of a sub-carrier-multiplexed and polarization-multiplexed received signal into a frequency domain signal; selecting a frequency domain signal corresponding to a sub-carrier; receiving, as input signals, a real number component and an imaginary number component of each polarization of each sub-carrier and frequency inversion and phase conjugation, performing a first equalization process of multiplying, for each sub-carrier and polarization, the real number component and the imaginary number component of each polarization included in the input signal by a complex transfer function and then adding them and performing inverse conversion from a frequency domain signal into a time domain signal and a second equalization process of performing a signal of a real number component obtained by subjecting the real number component of each polarization included in the input signal to frequency inversion and taking complex conjugation and a signal of an imaginary number component obtained by subjecting the imaginary number component to frequency inversion and taking complex conjugation by a complex transfer function and then adding them, and performing inverse conversion from a frequency domain signal into a time domain signal, and adding or subtracting the transmission data bias correction signal to or from the signal obtained by adding the first addition signal and the second addition signal.

### TECHNICAL FIELD

The present invention relates to a signal processing method, a signal processing device, and a communication system.

### BACKGROUND ART

Digital coherent transmission requires not only compensation for waveform distortion occurring in an optical fiber transmission line, but also adaptive compensation for device imperfections in optical transceivers. Adaptive equivalent circuits used in general signal processing mainly compensate for waveform distortion which occurs in the transmission path and compensation for device imperfections in the transmitter and receiver must be separately performed in subsequent signal processing. Therefore, there is a technique which collectively compensates for device imperfections in the transmitter and receiver (refer to, for example, PTL 1 and NPL 1).

### CITATION LIST

### Patent Literature

[PTL 1] Japanese Patent Application Publication No. 2020-141294

### Non Patent Literature

[NPL 1] Takayuki Kobayashi, et al., “35-Tb/s C-Band Transmission Over 800 km Employing 1-Tb/s PS-64 QAM Signals Enhanced by Complex 8×2 MIMO Equalizer”, Optical Fiber Communication Conference Postdeadline Papers 2019, Th4B.2

### SUMMARY OF INVENTION

### Technical Problem

The adaptive equalization circuits of PTL 1 and NPL 1 have a different configuration from the 2×2 Multiple Input Multiple Output (MIMO) adaptive equalization circuit with complex number input and complex number output that is commonly used in conventional optical communications. In the adaptive equalization circuits of PTL 1 and NPL 1, there is no commonality or compatibility in the generated tap coefficients or the like and the total number of taps increases. For this reason, as the number of taps increases, the amount of calculation increases exponentially. Furthermore, the methods of PTL 1 and NPL 1 have a problem in that they cannot support multicarrier signals.

In view of the above circumstances, an object of the present invention is to provide a technique which can perform equalization processing even on multicarrier signals while reducing the amount of calculation in digital coherent optical transmission.

### Solution to Problem

An aspect of the present invention is a signal processing method including: a conversion step of converting a real number component and an imaginary number component of each polarization of a sub-carrier-multiplexed and polarization-multiplexed received signal into a frequency domain signal; a sub-carrier selection step of selecting a frequency domain signal corresponding to a sub-carrier; a signal input step of receiving, as input signals, a frequency domain signal of the real number component and a frequency domain signal of the imaginary number component of each polarization of each selected sub-carrier and a frequency domain signal after conversion obtained by subjecting a center frequency of the selected sub-carrier on a frequency axis of the frequency domain signal of the real number component and the frequency domain signal of the imaginary number component of each polarized wave of sub-carriers forming a pair of sub-carriers which are line-symmetrical with respect to a direct current (DC) component to frequency inversion and taking complex conjugation; an equalization step of performing, for each sub-carrier and polarization, a first equalization process of multiplying each of the frequency domain signal of the real number component and the frequency domain signal of the imaginary number component of each polarization included in the input signal by a complex transfer function and then adding them and performing inverse conversion on them from a frequency domain signal into a time domain signal and a second equalization process of multiplying each of the frequency domain signal after the conversion of the real number component and the frequency domain signal after the conversion of the imaginary number component of each polarization included in the input signal by a complex transfer function and then adding them and performing inverse conversion on them from a frequency domain signal into a time domain signal; and a compensation step of performing, for each sub-carrier and each polarization, a phase rotation for frequency offset compensation on the time domain signal converted using the first equalization process to generate a first addition signal, performing a phase rotation opposite to the phase rotation for frequency offset compensation on the time domain signal converted using the second equalization process to generate a second addition signal, and adding or subtracting a transmission data bias correction signal to or from a signal obtained by adding the first addition signal and the second addition signal.

An aspect of the present invention is a signal processing method including: an addition processing step of performing an imaginary unit multiplication process in which an imaginary number component of each polarization of a sub-carrier-multiplexed and polarization-multiplexed received signal is multiplied by an imaginary unit j and then performing an addition process of adding an imaginary number component multiplied by the imaginary unit j and a real number component of each polarization of the sub-carrier-multiplexed and polarization-multiplexed received signal; a conversion step of converting a signal after addition processing of the imaginary number component multiplied by the imaginary unit j and the real number component into a frequency domain signal; a sub-carrier selection step of receiving, as inputs, a calculated frequency domain signal after calculation is performed on the frequency domain signal of each polarization and a calculated frequency domain signal after conversion after performing calculation on the frequency domain signal after conversion obtained by subjecting the frequency domain signal of each polarization to frequency inversion on the frequency axis and taking complex conjugation and selecting a frequency domain signal corresponding to a sub-carrier; a signal input step of receiving, as an input signal, the frequency domain signal corresponding to the sub-carrier selected in the sub-carrier selection step, either as it is or with compensation; an equalization step of performing, for each sub-carrier and polarization, a first equalization process of multiplying each of the calculated frequency domain signal of the real number component and the calculated frequency domain signal of the imaginary number component of each polarization included in the input signal by a complex transfer function and then adding them and performing inverse conversion on them from a frequency domain signal into a time domain signal and a second equalization process of multiplying each of the calculated frequency domain signal after converting the real number component of each polarization included in the input signal and the calculated frequency domain signal after converting the imaginary number component by a complex transfer function and then adding them and performing inverse conversion on them from a frequency domain signal to a time domain signal; and a compensation step of performing, for each sub-carrier and each polarization, a phase rotation for frequency offset compensation on a time domain signal converted using the first equalization process to generate a first addition signal, performing a phase rotation opposite to the phase rotation for frequency offset compensation on the time domain signal converted using the second equalization process to generate a second addition signal, and adding or subtracting a transmission data bias correction signal to or from a signal obtained by adding the first addition signal and the second addition signal.

An aspect of the present invention is a signal processing device including: a frequency conversion part which converts a real number component and an imaginary number component of each polarization of a sub-carrier-multiplexed and polarization-multiplexed received signal into a frequency domain signal; a sub-carrier selection portion which selects a frequency domain signal corresponding to a sub-carrier; a signal input part which receives, as input signals, a frequency domain signal of the real number component and a frequency domain signal of the imaginary number component of each polarization of each selected sub-carrier and a frequency domain signal after conversion obtained by subjecting a center frequency of the selected sub-carrier on a frequency axis of the frequency domain signal of the real number component and the frequency domain signal of the imaginary number component of each polarized wave of sub-carriers forming a pair of sub-carriers which are line-symmetrical with respect to a direct current (DC) component to frequency inversion and taking complex conjugation; an equalization part which performs, for each sub-carrier and polarization, a first equalization process of multiplying each of the frequency domain signal of the real number component and the frequency domain signal of the imaginary number component of each polarization included in the input signal by a complex transfer function and then adding them and performing inverse conversion on them from a frequency domain signal into a time domain signal and a second equalization process of multiplying each of the frequency domain signal after the conversion of the real number component and the frequency domain signal after the conversion of the imaginary number component of each polarization included in the input signal by a complex transfer function and then adding them and performing inverse conversion on them from a frequency domain signal into a time domain signal; and a compensation part which performs, for each sub-carrier and each polarization, a phase rotation for frequency offset compensation on the time domain signal converted using the first equalization process to generate a first addition signal, performs a phase rotation opposite to the phase rotation for frequency offset compensation on the time domain signal converted using the second equalization process to generate a second addition signal, and adds or subtracts a transmission data bias correction signal to or from a signal obtained by adding the first addition signal and the second addition signal.

An aspect of the present invention is a signal processing device including: an addition part which performs an imaginary unit multiplication process in which an imaginary number component of each polarization of a sub-carrier-multiplexed and polarization-multiplexed received signal is multiplied by an imaginary unit j and then performs an addition process of adding an imaginary number component multiplied by the imaginary unit j and a real number component of each polarization of the sub-carrier-multiplexed and polarization-multiplexed received signal; a conversion part which converts a signal after addition processing of the imaginary number component multiplied by the imaginary unit j and the real number component into a frequency domain signal; a sub-carrier selection part which receives, as inputs, a calculated frequency domain signal after conversion after performing calculation on the frequency domain signal after conversion obtained by subjecting the frequency domain signal of each polarization to frequency inversion on the frequency axis and taking complex conjugation and selects a frequency domain signal corresponding to a sub-carrier; a signal input part which receives, as an input signal, the frequency domain signal corresponding to the sub-carrier selected in the sub-carrier selection step, either as it is or with compensation; an equalization part which performs, for each sub-carrier and polarization, a first equalization process of multiplying each of the calculated frequency domain signal of the real number component and the calculated frequency domain signal of the imaginary number component of each polarization included in the input signal by a complex transfer function and then adding them and performing inverse conversion on them from a frequency domain signal into a time domain signal and a second equalization process of multiplying each of the calculated frequency domain signal after converting the real number component of each polarization included in the input signal and the calculated frequency domain signal after converting the imaginary number component by a complex transfer function and then adding them and performing inverse conversion on them from a frequency domain signal to a time domain signal; and a compensation part which performs, for each sub-carrier and each polarization, a phase rotation for frequency offset compensation on a time domain signal converted using the first equalization process to generate a first addition signal, performs a phase rotation opposite to the phase rotation for frequency offset compensation on the time domain signal converted using the second equalization process to generate a second addition signal, and adds or subtracts a transmission data bias correction signal to or from a signal obtained by adding the first addition signal and the second addition signal.

An aspect of the present invention is a communication system including: a transmitter which transmits a polarization multiplexed signal subjected to sub-carrier multiplexing and polarization multiplexing; and a receiver having the above signal processing device.

### Advantageous Effects of Invention

According to the present invention, it becomes possible to perform equalization processing even on multicarrier signals while reducing the amount of calculation in digital coherent optical transmission.

### BRIEF DESCRIPTION OF DRAWINGS

FIG. 1 is a diagram illustrating a configuration example of a digital coherent optical transmission system in a first embodiment.

FIG. 2 is a diagram illustrating an example of a configuration of a demodulated digital signal processing art in the first embodiment.

FIG. 3 is a diagram illustrating an example of a coefficient calculation part.

FIG. 4 is a diagram illustrating an example of the coefficient calculation part.

FIG. 5 is a diagram illustrating an example of the coefficient calculation part.

FIG. 6 is a diagram illustrating an example of the coefficient calculation part.

FIG. 7 is a diagram illustrating another example of a sub-carrier selection part.

FIG. 8 is a diagram illustrating another example of the sub-carrier selection part.

FIG. 9 is a diagram illustrating another example of the sub-carrier selection part.

FIG. 10 is a diagram for explaining the effects of the present invention.

FIG. 11 is a diagram for explaining the effects of the present invention.

FIG. 12 is a diagram illustrating an example of a configuration of a demodulation digital signal processing part in a second embodiment.

FIG. 13 is a diagram illustrating an example of a configuration of a demodulation digital signal processing part in a third embodiment.

### DESCRIPTION OF EMBODIMENTS

An embodiment of the present invention will be described below with reference to the drawings.

### First Embodiment

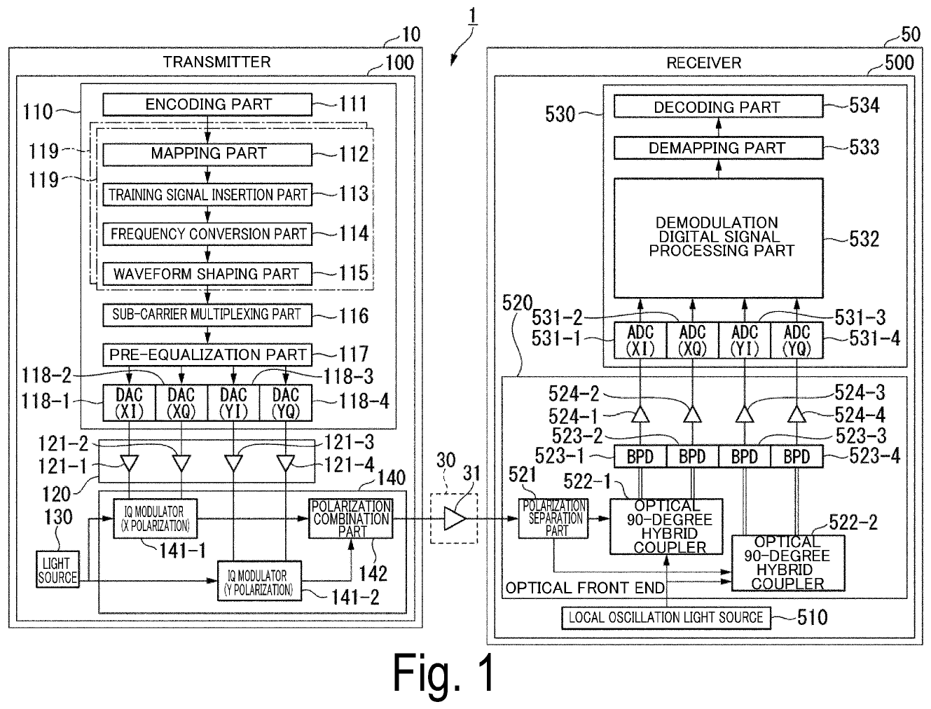

FIG. 1 is a diagram illustrating a configuration example of a digital coherent optical transmission system 1 in a first embodiment. The digital coherent optical transmission system 1 includes a transmitter 10 and a receiver 50. The transmitter 10 transmits a polarization multiplexed signal. The polarization multiplexed signal transmitted by the transmitter 10 is a sub-carrier multiplexed signal. The receiver 50 receives a polarization multiplexed signal from the transmitter 10. The transmitter 10 includes at least one transmission part 100. The transmission part 100 outputs a polarization multiplexed signal of a specified wavelength to an optical fiber transmission line 30. The optical fiber transmission line 30 includes an arbitrary number of optical amplifiers 31. Each of the optical amplifiers 31 inputs a polarization multiplexed signal from the optical fiber transmission line 30 on the transmitter 10 side, amplifies it, and outputs it to the optical fiber transmission line 30 on the receiver 50 side. The receiver 50 includes at least one receiving part 500. The receiving part 500 receives a polarization multiplexed signal.

First, a configuration of the transmitter 10 will be explained.

The transmission part 100 includes a digital signal processing part 110, a modulator driver 120, a light source 130, and an integration module 140. The digital signal processing part 110 includes an encoding part 111, a mapping part 112, a training signal insertion part 113, a frequency conversion part 114, a waveform shaping part 115, a sub-carrier multiplexing part 116, a pre-equalization part 117, and a digital-to-analog converter (DAC) 118-1 to 118-4. Note that, in order to perform sub-carrier multiplexing, the transmission part 100 includes a signal generation part 119 which includes the mapping part 112, the training signal insertion part 113, the frequency conversion part 114, and the waveform shaping part 115 as many as the number of sub-carriers.

The encoding part 111 performs forward error correction (FEC) encoding on the transmission bit string and outputs an obtained transmission signal.

The mapping part 112 maps a transmission signal output from the encoding part 111 into a symbol.

The training signal insertion part 113 inserts a known training signal into the transmission signal symbol-mapped using the mapping part 112.

The frequency conversion part 114 performs up-sampling by changing a sampling frequency for the transmission signal into which the training signal has been inserted.

The waveform shaping part 115 limits a band of the sampled transmission signal.

The sub-carrier multiplexing part 116 sub-carrier multiplexes the signals generated by each signal generation part 119.

The pre-equalization part 117 compensates for distortion in the waveform of the transmission signal sub-carrier multiplexed using the sub-carrier multiplexing part 116 and outputs it to the DACs 118-1 to 118-4.

The DAC 118-1 converts an I (in-phase) component of an X-polarized wave of a transmission signal input from the pre-equalization part 117 from a digital signal into an analog signal and outputs it to a modulator driver 120. The DAC 118-2 converts a Q (orthogonal) component of an X polarization of a transmission signal input from the pre-equalization part 117 from a digital signal into an analog signal and outputs the analog signal to the modulator driver 120. The DAC 118-3 converts a Y-polarized I component of a transmission signal input from the pre-equalization part 117 from a digital signal into an analog signal and outputs it to the modulator driver 120. The DAC 118-4 converts a Q component of a Y polarization of a transmission signal input from the pre-equalization part 117 from a digital signal into an analog signal and outputs the analog signal to the modulator driver 120.

The modulator driver 120 has amplifiers 121-1 to 121-4. The amplifier 121-i (i is an integer from 1 to 4) amplifies the analog signal output from the DAC 118-i and drives the modulator of the integration module 140 with the amplified analog signal.

The light source 130 is, for example, an LD (semiconductor laser). The light source 130 outputs light of a specified wavelength.

The integration module 140 includes IQ modulators 141-1 and 141-2 and a polarization combination part 142. The IQ modulator 141-1 modulates the optical signal output from the light source 130 to generate an X-polarized optical signal on the basis of the I component of the X-polarized wave output from the amplifier 121-1 and the Q component of the X-polarized wave output from the amplifier 121-2. The IQ modulator 141-2 modulates the optical signal output from the light source 130 to generate a Y-polarized optical signal on the basis of the I component of the Y-polarized wave output from the amplifier 121-3 and the Q component of the Y-polarized wave output from the amplifier 121-4. The polarization combination part 142 polarization-multiplexes the X-polarized optical signal generated by the IQ modulator 141-1 and the Y-polarized optical signal generated by the IQ modulator 141-2 to generate a polarization-multiplexed signal. The polarization combination part 142 outputs the generated polarization-multiplexed signal to the optical fiber transmission line 30.

The configuration of the receiver 50 will be explained below. The receiving part 500 includes a local oscillation light source 510, an optical front end 520, and a digital signal processing part 530. The local oscillation light source 510 is, for example, an LD. The local oscillation light source 510 outputs local oscillator light (LO).

The optical front end 520 converts the optical signal into an electrical signal while maintaining the phase and amplitude of the polarization-multiplexed phase-modulated signal. The optical front end 520 includes a polarization separation part 521, optical 90-degree hybrid couplers 522-1 and 522-2, balanced photo diodes (BPDs) 523-1 to 523-4, and amplifiers 524-1 to 524-4.

The polarization separation part 521 separates the input optical signal into an X-polarized optical signal and a Y-polarized optical signal. The polarization separation part 521 outputs the X-polarized optical signal to the optical 90-degree hybrid coupler 522-1 and outputs the Y-polarized optical signal to the optical 90-degree hybrid coupler 522-2.

The optical 90-degree hybrid coupler 522-1 interferes the X-polarized optical signal with the local oscillation light output from the local oscillation light source 510 and separates the I-component optical signal and Q-component optical signal of the received optical electric field. The optical 90-degree hybrid coupler 522-1 outputs the extracted I-component optical signal and Q-component optical signal of the X polarization to the BPDs 523-1 and 523-2.

The optical 90-degree hybrid coupler 522-2 causes the Y-polarized optical signal to interfere with the local oscillation light output from the local oscillation light source 510 and extracts the I component and the Q component of the received optical electric field. The optical 90-degree hybrid coupler 522-2 outputs the extracted I component and Q component of the Y polarization to the BPD 523-3 and the BPD 523-4.

The BPDs 523-1 to 523-4 are differential input type photoelectric converters. The BPD 523-i outputs a difference value between the photocurrents generated in the two photodiodes with the same characteristics to the amplifier 524-i. The BPD 523-1 converts the I component of the X-polarized received signal into an electrical signal and outputs it to the amplifier 524-1. The BPD 523-2 converts the Q component of the X-polarized received signal into an electrical signal and outputs it to the amplifier 524-2. The BPD 523-3 converts the I component of the Y-polarized received signal into an electrical signal and outputs it to the amplifier 524-3. The BPD 523-4 converts the Q component of the Y-polarized received signal into an electrical signal and outputs it to the amplifier 524-4. The amplifier 524-i (i is an integer from 1 to 4) amplifies the electrical signal output from the BPD 523-i and outputs it to the digital signal processing part 530.

The digital signal processing part 530 includes an analog-to-digital converters (ADCs) 531-1 to 531-4, a demodulation digital signal processing part 532, a demapping part 533, and a decoding part 534. Note that some functional parts for performing signal processing using the demodulation digital signal processing part 532 are provided as many as the number of sub-carriers.

The ADC 531-i (i is an integer from 1 to 4) converts the electrical signal output from the amplifier 524-i from an analog signal into a digital signal and outputs it to the demodulation digital signal processing part 532.

The demodulation digital signal processing part 532 receives, as inputs, the I component of the X-polarized received signal from the ADC 531-1, the Q component of the X-polarized received signal from the ADC 531-2, the I component of the Y-polarized received signal from the ADC 531-3, and the Q component of the Y-polarized received signal from the ADC 531-4. The demodulation digital signal processing part 532 performs signal processing such as at least equalization processing, frequency offset and phase noise compensation on each input signal. Note that the demodulation digital signal processing part 532 performs signal processing such as frequency characteristic compensation and chromatic dispersion compensation as necessary.

A determination concerning whether the demodulation digital signal processing part 532 performs signal processing such as frequency characteristic compensation and chromatic dispersion compensation depends on the configuration of the demodulation digital signal processing part 532. For this reason, when explaining the configuration of demodulation digital signal processing part 532, it will be specifically explained. The demodulation digital signal processing part 532 is an aspect of a signal processing device.

The demapping part 533 determines the symbol of the received signal output by the demodulation digital signal processing part 532 and converts the determined symbol into binary data.

The decoding part 534 performs error correction decoding processing such as FEC on the binary data demapped using the demapping part 533 to obtain a received bit string.

Note that, although the above embodiment describes an example of a single optical fiber transmission line, the same applies to spatially multiplexed transmission systems (for example, multi-core fiber, multi-mode fiber, and free space transmission).

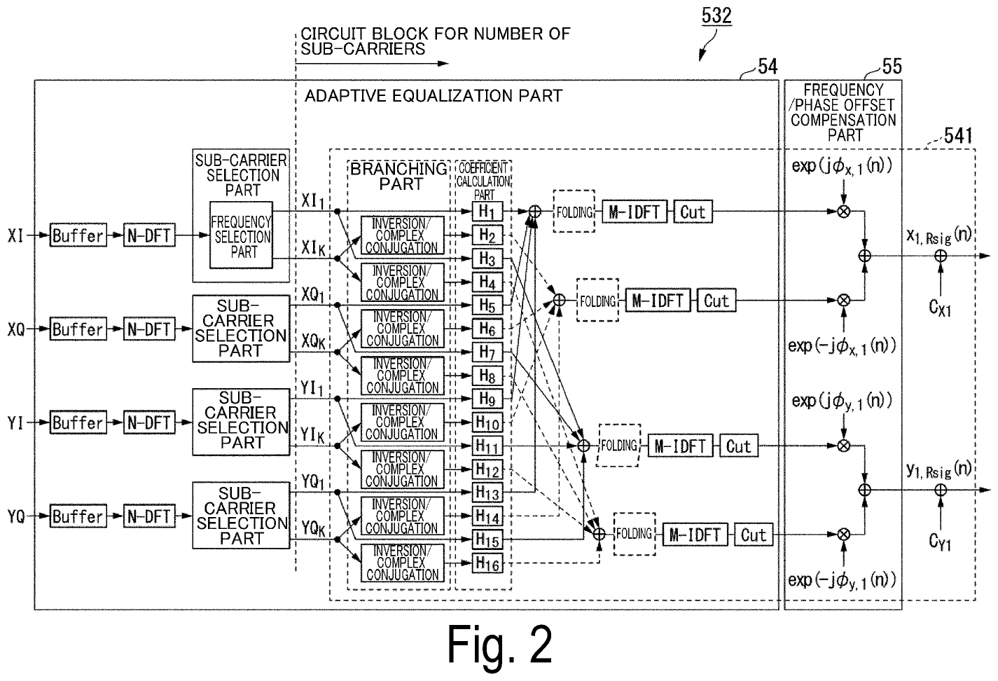

The configuration of the demodulation digital signal processing part 532 will be explained below. FIG. 2 is a diagram illustrating an example of a configuration of the demodulation digital signal processing part 532 in the first embodiment. The demodulation digital signal processing part 532 shown in FIG. 2 performs signal processing such as equalization processing, frequency offset, and phase noise compensation. Note that the demodulation digital signal processing part 532 shown in FIG. 2 does not perform signal processing such as frequency characteristic compensation and chromatic dispersion compensation.

The demodulation digital signal processing part 532 includes an adaptive equalization part 54 and a frequency/phase offset compensation part 55. The adaptive equalization part 54 adaptively performs equalization processing on each input signal. The frequency/phase offset compensation part 55 performs processing such as frequency offset and phase noise compensation on the received signal which has been equalized using the adaptive equalization part 54. Note that the demodulation digital signal processing part 532 includes the configuration surrounded by dotted lines 541 for the number of sub-carriers. The configuration shown in FIG. 2 is a configuration that performs processing regarding the first sub-carrier. The configuration for performing processing regarding the second sub-carrier is the same as the configuration for performing processing regarding the first sub-carrier, except that the sub-carrier numbers are different. For this reason, a configuration that performs processing regarding the first sub-carrier will be described as an example.

The operation of the demodulation digital signal processing part 532 will be explained below. The adaptive equalization part 54 of the demodulation digital signal processing part 532 receives, as inputs, the real number component XI and the imaginary number component XQ of the X-polarized reception signal converted into digital signals using the ADCs 531-1 to 531-4 and the real number component YI and the imaginary number component YQ of the Y-polarized received signal. The adaptive equalization part 54 stores each of the input real number component XI, the imaginary number component XQ, the real number component YI, and the imaginary number component YQ in a corresponding buffer. The buffer corresponds to the buffer used in the Overlap Save method described in Reference 1 below.

### (Reference 1: JOHN J. SHYNK, “Frequency-Domain and Multirate Adaptive Filtering”, January 1992.)

The adaptive equalization part 54 performs discrete Fourier transform or fast Fourier transform of N (N is a natural number) points on each of the real number component XI, imaginary number component XQ, the real number component YI, and the imaginary number component YQ stored in the buffer (corresponding to “N-DFT” shown in FIG. 2). Thus, the adaptive equalization part 54 converts the real number component and the imaginary number component of each polarized wave into a frequency domain signal. That is to say, the adaptive equalization part 54 generates a frequency domain signal of the real number component XI, a frequency domain signal of the imaginary number component XQ, a frequency domain signal of the real number component YI, and a frequency domain signal of the imaginary number component YQ.

Each of the frequency domain signal of the real number component XI, the frequency domain signal of the imaginary number component XQ, the frequency domain signal of the real number component YI, and the frequency domain signal of the imaginary number component YQ generated using the adaptive equalization part 54 is input to the sub-carrier selection part. The sub-carrier selection part outputs frequency domain signals in a frequency range corresponding to at least sub-carriers 1 to K (K is an integer of 2 or more). The sub-carrier selection part shown in FIG. 2 only performs frequency selection for sub-carrier signal separation and does not perform compensation coefficients.

The sub-carrier selection part (first stage sub-carrier selection part) provided in an I lane of X polarization selects and outputs a frequency domain signal XI₁ in a frequency range corresponding to a first sub-carrier of the real number component XI and a frequency domain signal XI_{K} in a frequency range corresponding to a Kth sub-carrier of the real number component XI. Note that, when the sub-carrier selection part outputs the second sub-carrier, it selects and outputs a second sub-carrier and a (K−1) th sub-carrier. When the sub-carrier selection part outputs the kth sub-carrier (an integer of 1≤k≤K), it selects and outputs the kth sub-carrier and a (K−k+1) th sub-carrier.

The frequency domain signal XI₁ of the first sub-carrier of the real number component XI output using the sub-carrier selection part is branched into two and the two branched frequency domains are input as they are to the coefficient calculation part. On the other hand, the frequency domain signal XI_{K} of the Kth sub-carrier of the real number component XI output using the sub-carrier selection part is branched into two and the two branched frequency domains are converted using the inversion/complex conjugation part into frequency domain signals which are subjected to inversion and has complex conjugation taken and are input to the coefficient calculation part.

Here, a frequency domain signal which has been subjected to inversion and has complex conjugation taken is a signal which has been inverted around DC in the frequency domain and has been complex conjugated to generate a complex conjugate signal in the time domain and perform equivalent operations in the frequency domain. Considering a signal X(f) in a certain frequency domain, the inversion/complex conjugation part outputs a signal X^{†}(−f). Hereinafter, the real number component frequency domain signal converted using the inversion/complex conjugate part will be referred to as a “real number component inverted complex conjugate signal”.

Similarly, the sub-carrier selection part (second stage sub-carrier selection part) provided in the Q lane of X polarization selects and outputs a frequency domain signal XQ₁ of the first sub-carrier of the imaginary number component XQ and a frequency domain signal XQ_{K} of the Kth sub-carrier of the imaginary number component XQ. The frequency domain signal XQ₁ of the first sub-carrier of the imaginary number component XQ output using the sub-carrier selection part is branched into two and the two branched frequency regions are input as they are to the coefficient calculation part.

On the other hand, the frequency domain signal XQ_{K} of the Kth sub-carrier of the imaginary number component XQ output using the sub-carrier selection part is branched into two, the two branched frequency domains are converted into a frequency domain signal which has been subjected to inversion and has complex conjugation taken using the inversion/complex conjugation part and are input to the coefficient calculation part. Hereinafter, the frequency domain signal of the imaginary number component converted using the inversion/complex conjugate part will be referred to as “imaginary number component inverted complex conjugate signal”.

Similarly, the sub-carrier selection part (third stage sub-carrier selection part) provided in the I lane of Y polarization selects and outputs a frequency domain signal YI₁ of the first sub-carrier of the real number component YI and a frequency domain signal YI_{K} of the Kth sub-carrier of the real number component YI. The frequency domain signal YI₁ of the first sub-carrier of the real number component YI output using the sub-carrier selection part is branched into two and the two branched frequency regions are input as they are to the coefficient calculation part. On the other hand, the frequency domain signal YI_{K} of the Kth sub-carrier of the real number component YI output using the sub-carrier selection part is branched into two and the two branched frequency domains are converted into a frequency domain signal which has subjected to inversion and has complex conjugation taken and are input to the coefficient calculation part.

Similarly, the sub-carrier selection part (fourth stage sub-carrier selection part) provided in the Q lane of Y polarization selects and outputs a frequency domain signal YQ₁ of the first sub-carrier of the imaginary number component YQ and a frequency domain signal YQ_{K} of the Kth sub-carrier of the imaginary number component YQ. The frequency domain signal YQ₁ of the first sub-carrier of the imaginary number component YQ output using the sub-carrier selection part is branched into two and the two branched frequency regions are input as they are to the coefficient calculation part.

On the other hand, the frequency domain signal YQ_{K} of the Kth sub-carrier of the imaginary number component YQ output by the sub-carrier selection part is branched into two and the two branched frequency domains are converted into a frequency domain signal which has been subjected to inversion and has complex conjugation taken and are input to the coefficient calculation part.

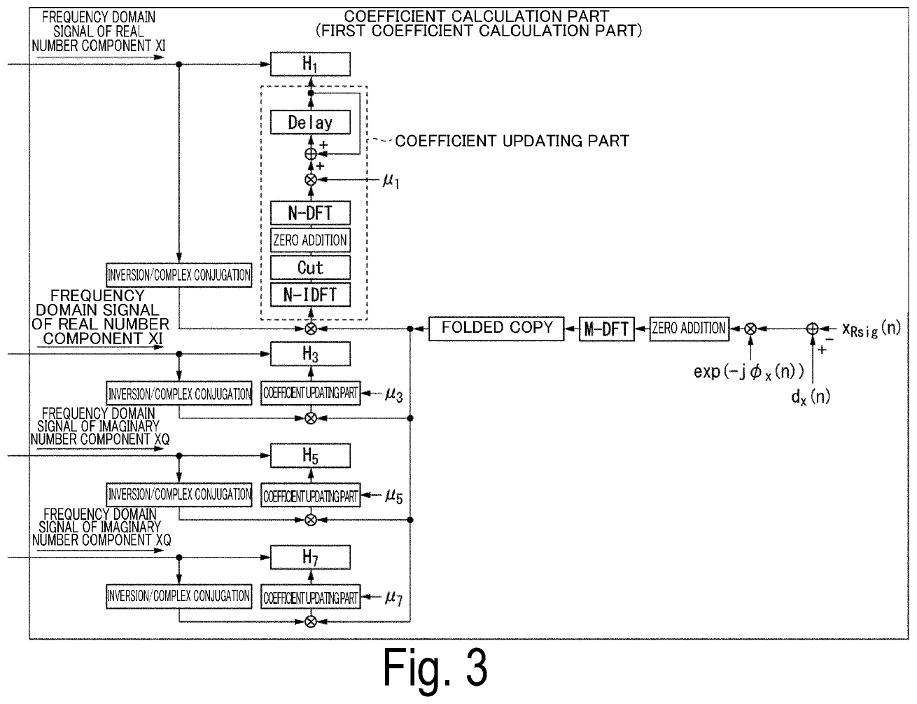

The coefficient calculation part multiplies the input signal by the complex transfer function of impulse responses H₁ to H₁₆ for each sub-carrier. That is to say, the impulse responses H₁ to H₁₆ exist for each sub-carrier and are updated independently. Note that, although FIG. 2 shows only the values of the impulse responses H₁ to H₁₆ as a coefficient calculation part, the specific configuration of the coefficient calculation part will be explained with reference to FIGS. 3 to 6.

The adaptive equalization part 54 adds the frequency domain signal XI₁ of the first sub-carrier of the real number component XI multiplied by the complex transfer function of the impulse response H₁, the frequency domain signal XQ₁ of the first sub-carrier of the imaginary number component XQ multiplied by the complex transfer function of the impulse response Hs, the frequency domain signal YI₁ of the first sub-carrier of the real number component YI multiplied by the complex transfer function of the impulse response H₉, and the frequency domain signal YQ₁ of the first sub-carrier of the imaginary number component YQ multiplied by the complex transfer function of the impulse response H₁₃ and generates an addition signal. After that, the addition signal generated using the adaptive equalization part 54 is subjected to folding processing in the frequency domain. The folding process is a process of folding the Nyquist frequency axisymmetrically and adding components of frequencies whose absolute values are larger than a frequency (Nyquist frequency) that is half the symbol rate. This processing corresponds to down-sampling processing in the time domain.

The adaptive equalization part 54 performs inverse discrete Fourier transform or inverse fast Fourier transform of M (M is a natural number, N≥_K×M) points on the addition signal which has been subjected to the folding process (corresponding to “M-IDFT” shown in FIG. 2). Thus, the adaptive equalization part 54 converts the frequency domain signal into a time domain signal. After that, the adaptive equalization part 54 performs signal cutting processing using the Overlap Save method on the time domain signal (corresponding to “Cut” shown in FIG. 2).

In order to realize the above processing, the adaptive equalization part 54 includes a buffer, a Fourier transform part, a branch part, a coefficient calculation part, an addition part, a folding part, an inverse Fourier transform part, and a cut part.

Note that, although the above example shows a configuration in which folding, M-IDFT, and Cut processing are performed in this order, it may be configured such that M-IDFT, Cut, and down-sampling processing is performed in this order.

The frequency/phase offset compensation part 55 multiplies the addition signal extracted using the adaptive equalization part 54 as described above using the frequency offset exp (jφ_{x,1}(n)). n represents a symbol interval.

The adaptive equalization part 54 adds the real number component inverted complex conjugate signal XI_{K}^{†}(−f) multiplied by the complex transfer function of the impulse response H₂, the imaginary number component inverted complex conjugate signal XQₖ^{†}(−f) multiplied by the complex transfer function of the impulse response H₆, the real number component inverted complex conjugate signal YIₖ^{†}(−f) multiplied by the complex transfer function of the impulse response H₁₀, and the imaginary number component inverted complex conjugate signal YQₖ^{†}(−f) multiplied by the complex transfer function of the impulse response H₁₄ and generates an addition signal. After that, the addition signal generated using the adaptive equalization part 54 is subjected to folding, M-IDFT, and cut processing.

The frequency/phase offset compensation part 55 multiplies the addition signal extracted using the adaptive equalization part 54 as described above by the frequency offset exp(−jφ_{x,1}(n)). The frequency/phase offset compensation part 55 adds the addition signal multiplied by the frequency offset exp(jφ_{x,1}(n)) and the addition signal multiplied by the frequency offset exp(−jφ_{x,1}(n)) and obtains the received signal of the first sub-carrier of the X polarization component.

The demodulation digital signal processing part 532 adds (or subtracts) a transmission data bias correction signal C_{X1} for canceling the bias shift of the X polarization component to (from) the received signal of the first sub-carrier of the obtained X polarization component and obtains the received signal X_{1,Rsig}(n) of the first sub-carrier of the X-polarized wave component subjected to distortion correction.

On the other hand, the adaptive equalization part 54 adds the real number component XI₁(f) multiplied by the complex transfer function of the impulse response H₃, the imaginary number component XQ₁(f) multiplied by the complex transfer function of the impulse response H₇, the real number component YI₁(f) multiplied by the complex transfer function of the impulse response H₁₁, and the imaginary number component YQ₁(f) multiplied by the complex transfer function of impulse response H₁₅ and generates an addition signal. After that, the addition signal generated using the adaptive equalization part 54 is subjected to folding, M-IDFT, and cut processing. The frequency/phase offset compensation part 55 multiplies the addition signal extracted using the adaptive equalization part 54 using a frequency offset exp (jφ_{y,1}(n)).

The adaptive equalization part 54 adds the real number component inverted complex conjugate signal XI_{K}^{†}(−f) multiplied by the complex transfer function of the impulse response H₄, the imaginary number component inverted complex conjugate signal XQ_{K}^{†}(−f) multiplied by the complex transfer function of the impulse response H₁₂, the real number component inverted complex conjugate signal YI_{K}^{†}(−f) multiplied by the complex transfer function of the impulse response H₁₆, and the imaginary number component inverted complex conjugate signal YQ_{K}^{†}(−f) multiplied by the complex transfer function of the impulse response H₁₄ and generates an addition signal. After that, the addition signal generated using the adaptive equalization part 54 is subjected to folding, M-IDFT, and cut processing.

The frequency/phase offset compensation part 55 multiplies the addition signal extracted using the adaptive equalization part 54 as described above by the frequency offset exp(−jφ_{y,1}(n)). The frequency/phase offset compensation part 55 adds the addition signal multiplied by the frequency offset exp(jφ_{y,1}(n)) and the addition signal multiplied by the frequency offset exp(−jφ_{y,1}(n)) and obtains the received signal of the first sub-carrier of the Y polarization component.

The demodulation digital signal processing part 532 adds (or subtracts) a transmission data bias correction signal C_{Y1} for canceling the bias shift of the Y polarization component to (or from) the received signal of the first sub-carrier of the obtained Y polarization component and obtains the distortion-corrected received signal Y_{Rsig}(n) of the X polarization component.

Note that the value of N, the value of M, the impulse responses H₁ to H₁₆, and the frequency offset exp (jφ_{x,k}(n)), exp(−jφ_{x,k}(n)), exp(jφy,ₖ(n)), exp(−jφ_{y,k}(n)) is adaptively and dynamically changed. The receiver 50 obtains these values through any method.

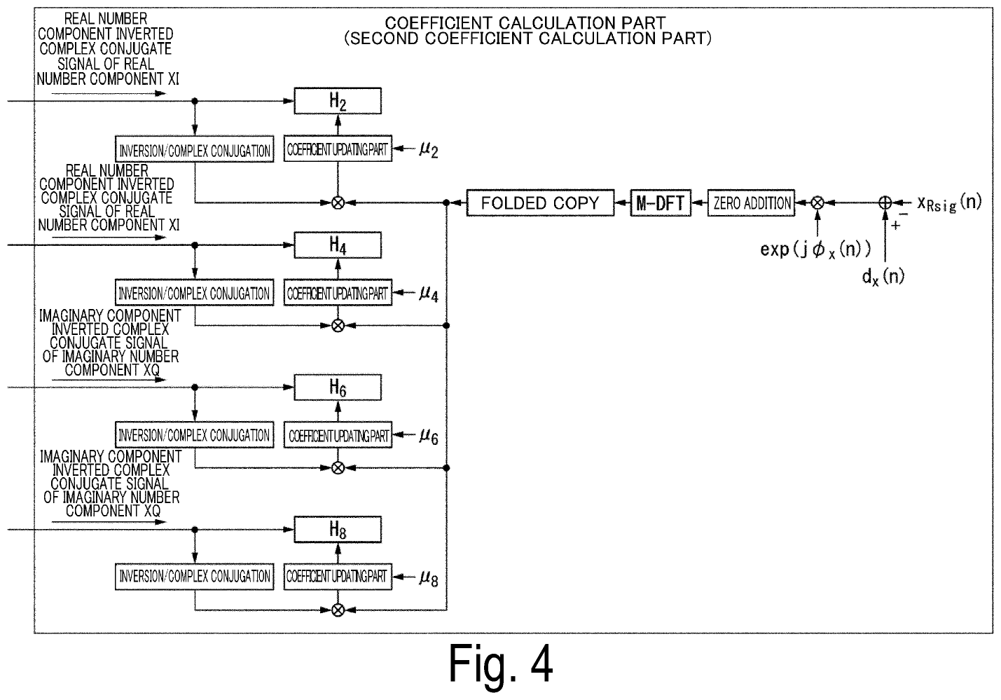

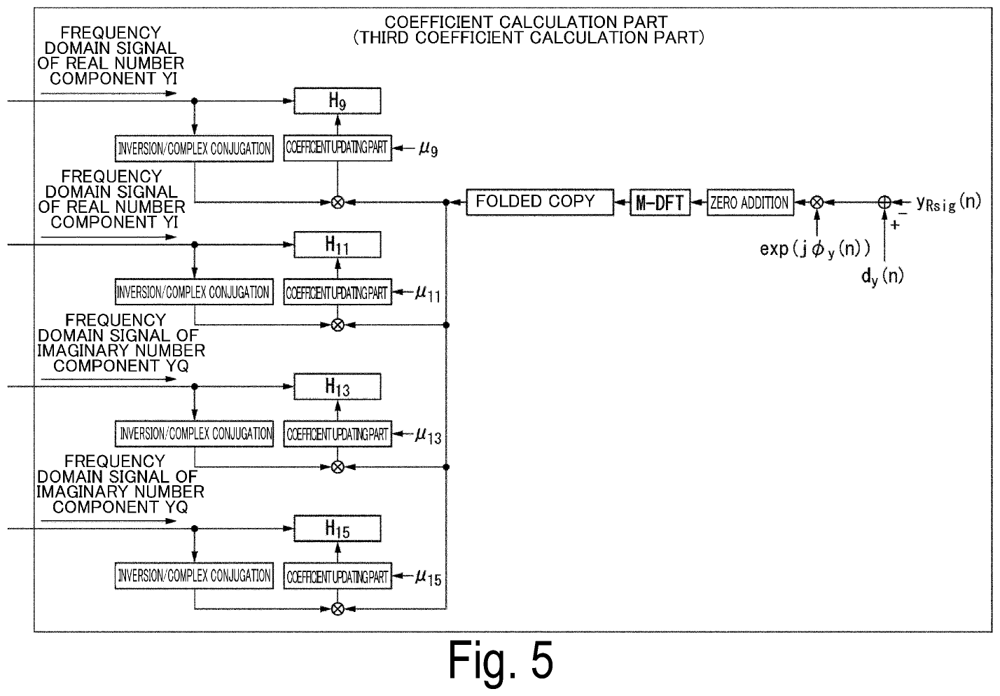

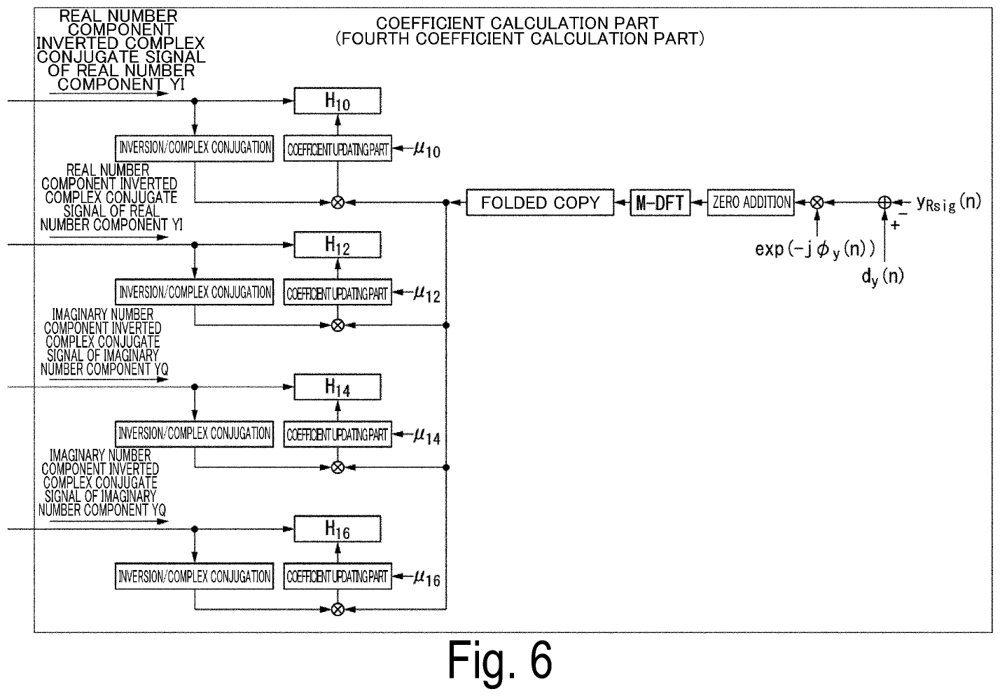

The configuration and the operation of the coefficient calculation part will be explained below. FIGS. 3 to 6 are diagrams illustrating an example of the configuration of the coefficient calculation part. As shown in FIGS. 3 to 6, the coefficient calculation part included in the demodulation digital signal processing part 532 includes four coefficient calculation parts. The coefficient calculation part shown in FIG. 3 is a functional part which calculates the impulse responses H₁, H₃, H₅, and H₇. The coefficient calculation part shown in FIG. 4 is a functional part which calculates the impulse responses H₂, H₄, H₆, and H₈. The coefficient calculation part shown in FIG. 5 is a functional part which calculates the impulse responses H₉, H₁₁, H₁₃, and H₁₅. The coefficient calculation part shown in FIG. 6 is a functional part which calculates the impulse responses H₁₀, H₁₂, H₁₄, and H₁₆. The coefficient calculation part includes a coefficient updating part. The coefficient updating part updates the value of the impulse response.

In the following description, the coefficient calculation part shown in FIG. 3 will be referred to as the “first coefficient calculation part”, the coefficient calculation part shown in FIG. 4 will be referred to as the “second coefficient calculation part”, and the coefficient calculation part shown in FIG. 5 will be referred to as a “third coefficient calculation part”, and the coefficient calculation part shown in FIG. 6 will be referred to as a “fourth coefficient calculation part”. Note that, when the first coefficient calculation part to the fourth coefficient calculation part are not particularly distinguished, they will simply be referred to as coefficient calculation parts. The operation of the coefficient calculation part will be explained below.

### (Operation of First Coefficient Calculation Part)

A frequency domain signal of the real number component XI and a frequency domain signal of the imaginary number component XQ are input to the first coefficient calculation part. The frequency domain signal of the real number component XI and the frequency domain signal of the imaginary number component XQ input to the first coefficient calculation part are branched into a first path and a second path. In the first path, the frequency domain signal of the real number component XI and the frequency domain signal of the imaginary number component XQ are multiplied by the complex transfer function updated using the coefficient updating part.

In the second path, the frequency domain signal of the real number component XI and the frequency domain signal of the imaginary number component XQ are converted into a frequency domain signal which has been subjected to inversion and has complex conjugation taken using the inversion/complex conjugation part. Thus, the frequency domain signal of the real number component XI input to the first coefficient calculation part is converted into a real number component inverted complex conjugate signal and the frequency domain signal of the imaginary number component XQ is converted into an imaginary number component inverted complex conjugate signal.

In the first coefficient calculation part, the real number component inverted complex conjugate signal and the imaginary number component inverted complex conjugate signal are multiplied by a signal based on the received signal. Here, the signal based on the received signal is a signal obtained on the basis of the following processes (1) to (5).

(1): Subtract the received signal (for example, X_{Rsig}(n)) from the reference signal (for example, dₓ(n))

(2): Multiply the signal obtained by the process (1) by a frequency offset (for example, exp(−jφₓ(n)))

(3): Add zero to the signal obtained by the process (2) (corresponds to “zero addition” shown in FIG. 3)

(4): Inverse discrete Fourier transform or inverse fast Fourier transform (corresponds to “M-DFT” shown in FIG. 3) of M points of the signal obtained in the process of (3)

(5): Copy the frequency domain signal obtained by the process in (4) in the frequency domain (corresponds to “back copy” shown in FIG. 3)

As the reference signal (for example, dₓ(n) or d_{y}(n)), a pilot signal inserted in advance on the transmitting side or a value temporarily determined from a received signal (for example, X_{Rsig}(n) or Y_{Rsig}(n)) is used. The process of adding zeros shown in (3) is a process of adding zeros to the input signal in a number M/N times the length of the signal to be cut in the Overlap Save method described in Reference 1. In the process of adding zeros, zeros are successively added to the input signal in a number M/N times the length of the signal to be cut. The frequency domain copy shown in (5) is a process of copying a frequency domain signal in a line-symmetric manner with the Nyquist frequency as a reference. Copying in the frequency domain shown in (5) corresponds to up-sampling processing in the time domain.

Note that, although the configuration in which zero addition, M-DFT, and loop copy processing are performed is shown in the above description, up-sampling and N-DFT processing may be performed instead.

The real number component inverted complex conjugate signal and the imaginary number component inverted complex conjugate signal multiplied by the signal based on the received signal are input to the coefficient updating part. In the coefficient updating part, the real number component inverted complex conjugate signal and the imaginary number component inverted complex conjugate signal multiplied by a signal based on the received signal are subjected to processing such as N-IDFT, Cut, zero addition, N-DFT, multiplication by step size μ, and addition of the value of the immediately previous impulse response. As the step size μ, a normalized LMS (Reference 1) in which the step size is normalized using the input signal power for each frequency bin may be used.

If the process of updating an impulse response H₁ is used as an example, as the processing of the first coefficient calculation part, the coefficient updating part first performs inverse discrete Fourier transform or inverse fast Fourier transform of N (for example, N=256) points on the real number component inverted complex conjugate signal multiplied by a signal based on the received signal (here, defined as a signal A1). Thus, the coefficient updating part converts the frequency domain signal A1 into a time domain signal A1. Subsequently, the coefficient updating part performs signal extraction processing using the Overlap Save method on the time domain signal A1. Subsequently, the coefficient updating part performs a process of adding zero to the time domain signal A1 which has been subjected to the extraction process. Subsequently, the coefficient updating part multiplies the zero-added time domain signal A1 by the step size μ₁. Subsequently, the coefficient updating part updates the value of the impulse response H₁ by adding the value of the impulse response H₁ obtained immediately before to the time domain signal A1 multiplied by the step size μ₁.

Note that the process of updating the impulse response H₃ in the first coefficient calculation part is the same as the process described above except that the step size value is different. Furthermore, the process of updating the impulse responses H₅ and H₇ in the first coefficient calculation part is similar to the process described above, except that the imaginary number component inverted complex conjugate signal multiplied by the signal based on the received signal is input to the coefficient updating part and the step size value is different.

### (Operation of Second Coefficient Calculation Part)

A real number component inverted complex conjugate signal of the real number component XI and an imaginary number component inverted complex conjugate signal of the imaginary number component XQ are input to the second coefficient calculation part. The real number component inverted complex conjugate signal of the real number component XI and the imaginary number component inverted complex conjugate signal of the imaginary number component XQ input to the second coefficient calculation part are branched into a first path and a second path. In the first path, the real number component inverted complex conjugate signal of the real number component XI and the imaginary number component inverted complex conjugate signal of the imaginary number component XQ are multiplied by the complex transfer function updated using the coefficient updating part.

In the second path, the real number component inverted complex conjugate signal of the real number component XI and the imaginary number component inverted complex conjugate signal of the imaginary number component XQ are converted into a frequency domain signal which has been subjected to inversion and has complex conjugation taken using the inversion/complex conjugation part. Thus, the real number component inverted complex conjugate signal of the real number component XI input to the second coefficient calculation part is converted into a frequency signal of the real number component XI and the imaginary number component inverted complex conjugate signal of the imaginary number component XQ is converted into a frequency domain signal of the imaginary number component XQ.

In the second coefficient calculation part, the frequency signal of the real number component XI and the frequency domain signal of the imaginary number component XQ are multiplied by a signal based on the above-described received signal. Here, in the signal based on the received signal in the second coefficient calculation part, the signal obtained in the process (1) is multiplied by the frequency offset exp(jφₓ(n)) as the frequency offset. The frequency signal of the real number component XI and the frequency domain signal of the imaginary number component XQ multiplied by the signal based on the received signal are input to the coefficient updating part. In the coefficient updating part, the frequency signal of the real number component XI and the frequency domain signal of the imaginary number component XQ multiplied by the signal based on the received signal are subjected to processing such as N-IDFT, Cut, zero addition, N-DFT, multiplication by step size μ, and addition of the value of the immediately previous impulse response. The processing performed by the coefficient updating part is the same as the processing described in FIG. 3. Thus, the description thereof will be omitted.

### (Operation of Third Coefficient Calculation Part)

The processing performed by the third coefficient calculation part is similar to the processing performed by the first coefficient calculation part, except that the input signal is a Y polarization signal, that the step size used in the coefficient updating part is different, and that, in the generation of a signal based on the received signal, as a frequency offset, the frequency offset exp(jφ_{y}(n)) is multiplied by the signal obtained by subtracting the received signal (for example, Y_{Rsig}(n)) from the reference signal (for example, d_{y}(n)).

### (Operation of Fourth Coefficient Calculation Part)

The processing performed by the fourth coefficient calculation part is similar to the processing performed by the second coefficient calculation part, except that the input signal is a Y polarization signal, that the step size used in the coefficient updating part is different, and that, in the generation of a signal based on the received signal, as a frequency offset, the frequency offset exp(−jφ_{y}(n)) is multiplied by the signal obtained by subtracting the received signal (for example, Y_{Rsig}(n)) from the reference signal (for example, d_{y}(n)).

Note that the processing of Cut and zero addition in the coefficient updating part corresponds to multiplication by a rectangular window function in the time domain. N-IDFT and N-DFT can be omitted and simplification is possible by changing the window function in the time domain to a Cosine window and processing it as convolution in the frequency domain.

According to the demodulation digital signal processing part 532 configured as above, the increase in the number of multiplications due to the convolution operation of time-domain coefficients is reduced by performing adaptive equalization in the frequency domain on a pair of frequency domain signals of sub-carriers separated in the frequency domain and frequency inverted complex conjugate signals of the frequency domain signals of sub-carriers which are line-symmetric with respect to the DC. For this reason, the amount of calculation can be reduced in response to multicarrier signals. Furthermore, since the amount of calculation can be reduced, it is possible to realize power saving of the receiver 50 of the digital coherent optical transmission system.

### (Modified Example of First Embodiment)

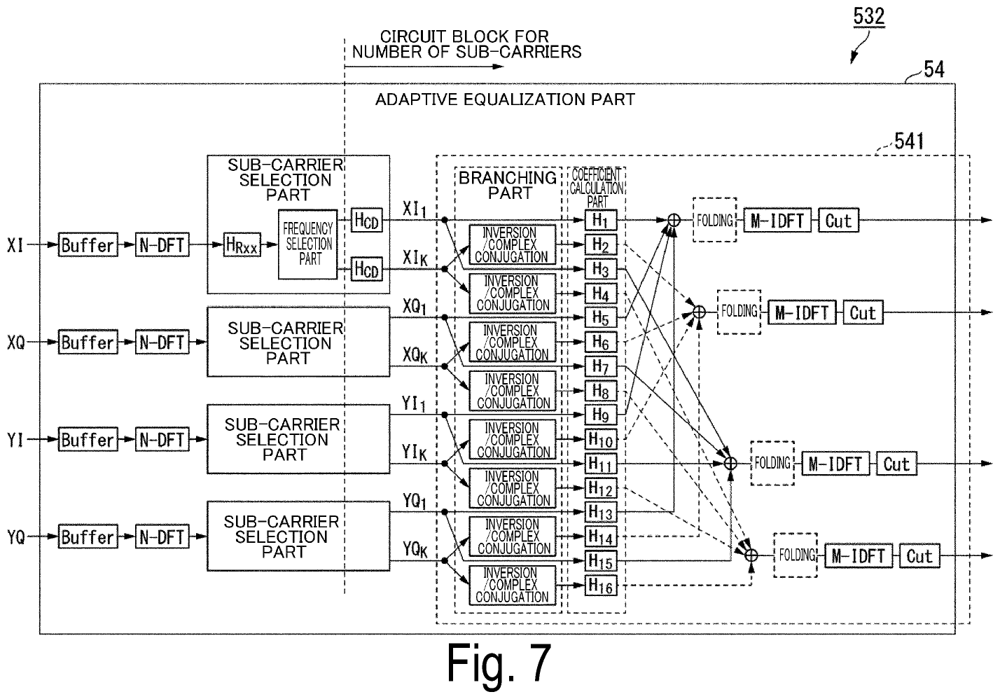

The configuration of the sub-carrier selection part included in the demodulation digital signal processing part 532 does not need to be limited to the configuration shown in FIG. 2. For example, the sub-carrier selection part may have any of the configurations shown in FIGS. 7 to 9. FIGS. 7 to 9 are diagrams illustrating other examples of the sub-carrier selection part. First, explanation will be provided with reference to FIG. 7.

In the configuration shown in FIG. 7, the sub-carrier selection part performs frequency characteristic compensation before the frequency selection part and performs dispersion compensation for each sub-carrier after the frequency selection part. The frequency domain signal of the real number component XI, the frequency domain signal of the imaginary number component XQ, the frequency domain signal of the real number component YI, and the frequency domain signal of the imaginary number component YQ are each multiplied by the receiver device characteristic compensation coefficient HRXX. Note that “XX” in RXX is one of “XI”, “XQ”, “YI”, and “YQ”. Each of the frequency domain signal of the real number component XI, the frequency domain signal of the imaginary number component XQ, the frequency domain signal of the real number component YI, and the frequency domain signal of the imaginary number component YQ, whose frequency characteristics have been compensated for, is input to the sub-carrier selection part. The sub-carrier selection part performs processing similar to the processing described above. The sub-carrier frequency domain signal output using the sub-carrier selection part is multiplied by a dispersion compensation coefficient H_{CD} for each sub-carrier.

When the sub-carrier selection part outputs the kth sub-carrier (an integer of 1≤k≤K), the kth sub-carrier and the (K−k+1) th sub-carrier are selected and multiplied by a dispersion compensation coefficient corresponding to the kth sub-carrier. The processing after the sub-carrier selection part outputs the signal is similar to the processing described above.

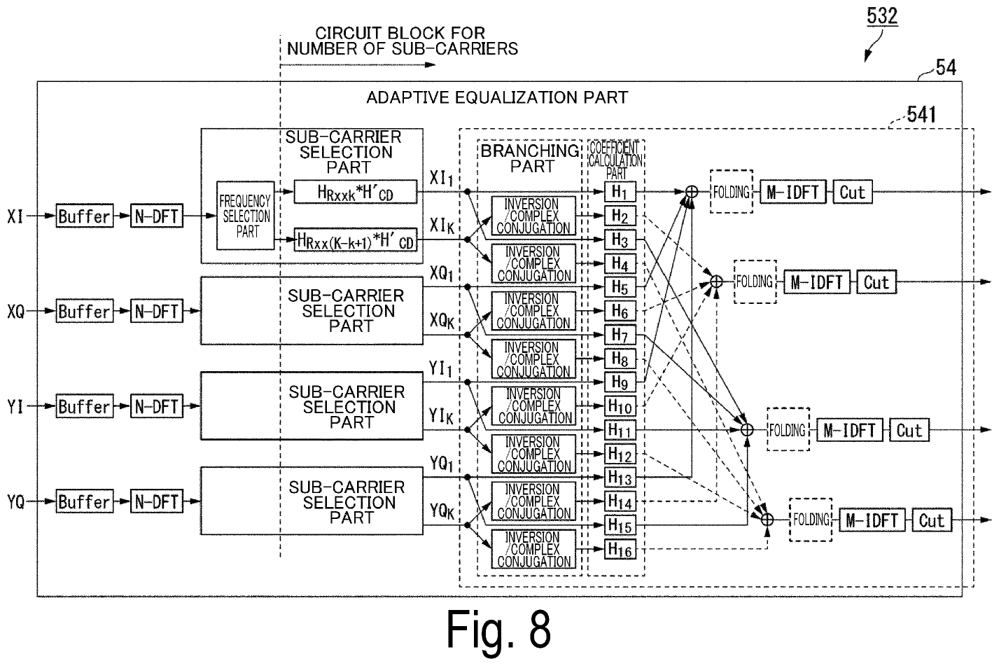

In the configuration shown in FIG. 8, the sub-carrier selection part performs signal processing such as frequency characteristic compensation and chromatic dispersion compensation at a subsequent stage of the frequency selection part. Each of the frequency domain signal of the real number component XI, the frequency domain signal of the imaginary number component XQ, the frequency domain signal of the real number component YI, and the frequency domain signal of the imaginary number component YQ, which are generated by the adaptive equalization part 54, is input to the sub-carrier selection part. The sub-carrier selection part performs processing similar to the processing described above. Each signal output from the frequency selection part is multiplied by a receiving side device characteristic compensation coefficient H_{RXNK-(K-k+1)} and a compensation coefficient H′_{CD}. H_{RXNK-(K-k+1)} represents a receiving side device characteristic compensation coefficient in the frequency range corresponding to sub-carriers 1 to K. The compensation coefficient H′_{CD} is a coefficient obtained by arranging dispersion compensation coefficients Hcp for each sub-carrier in the frequency direction.

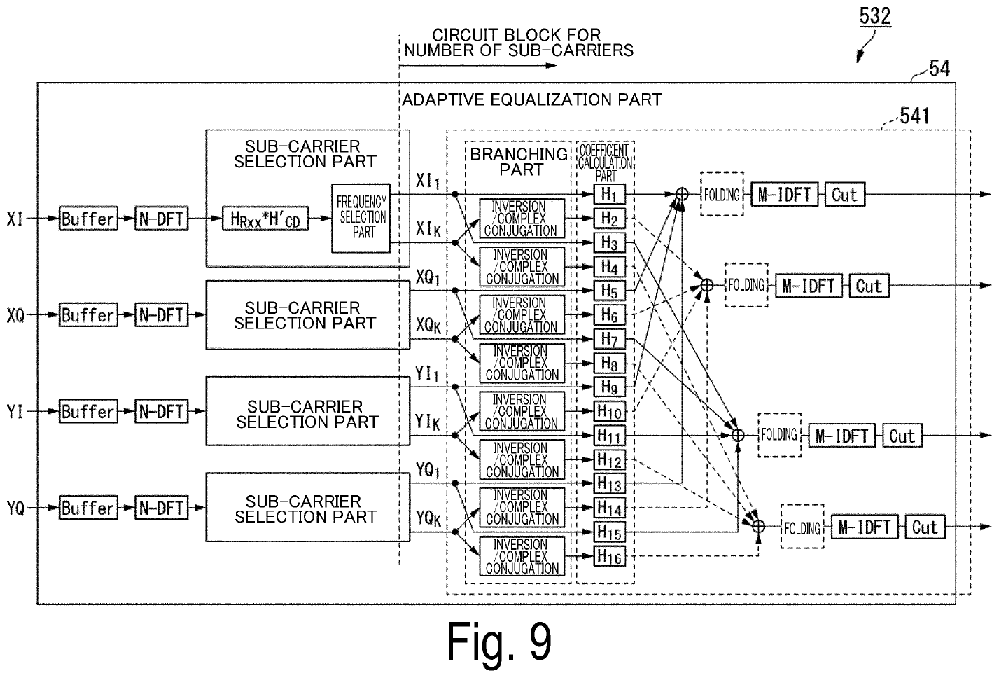

In the configuration shown in FIG. 9, the sub-carrier selection part performs signal processing such as frequency characteristic compensation and chromatic dispersion compensation before the frequency selection part. Each of the frequency domain signal of the real number component XI, the frequency domain signal of the imaginary number component XQ, the frequency domain signal of the real number component YI, and the frequency domain signal of the imaginary number component YQ is multiplied by a receiving side device characteristic compensation coefficient H_{RXX} and a compensation coefficient H′_{CD}. The sub-carrier selection part performs processing similar to the processing described above. The processing after the sub-carrier selection part outputs the signal is similar to the processing described above.

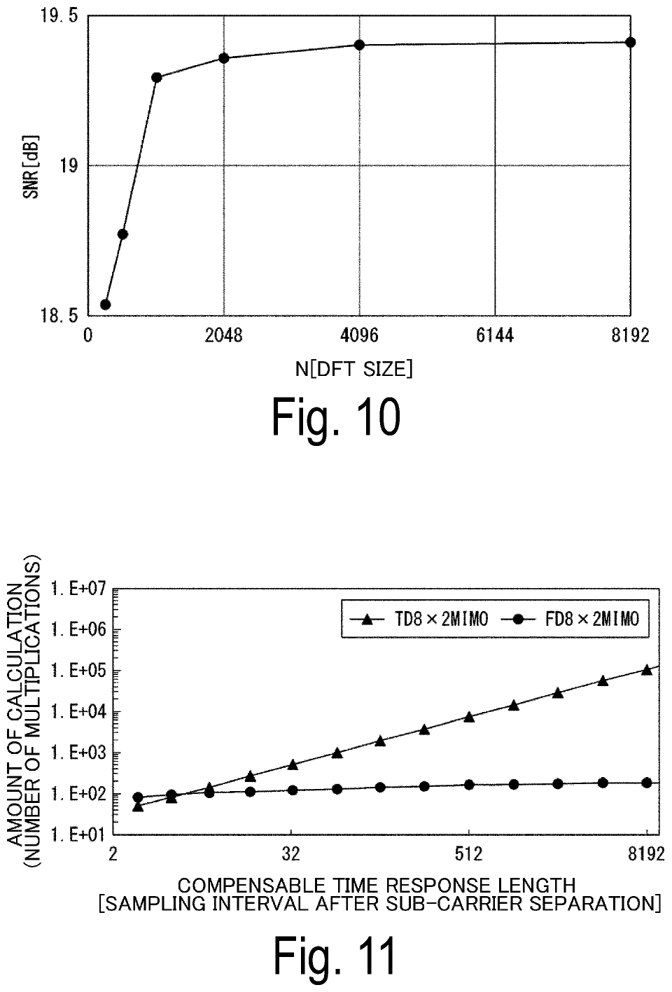

FIG. 10 is a diagram illustrating the N-DFT size dependence (DFT calculated using FFT) of received Signal-Noise Ratio (SNR) of 2 sub-carriers, 60 G Baud, 16 Quadrature Amplitude Modulation (QAM) using the configuration of the demodulation digital signal processing part 532 including the sub-carrier selection part shown in FIG. 7. As shown in FIG. 10, it can be seen that, when the DFT size is increased, the compensable time response (frequency resolution) increases, and thus the received signal-to-noise ratio (SNR) is improved.

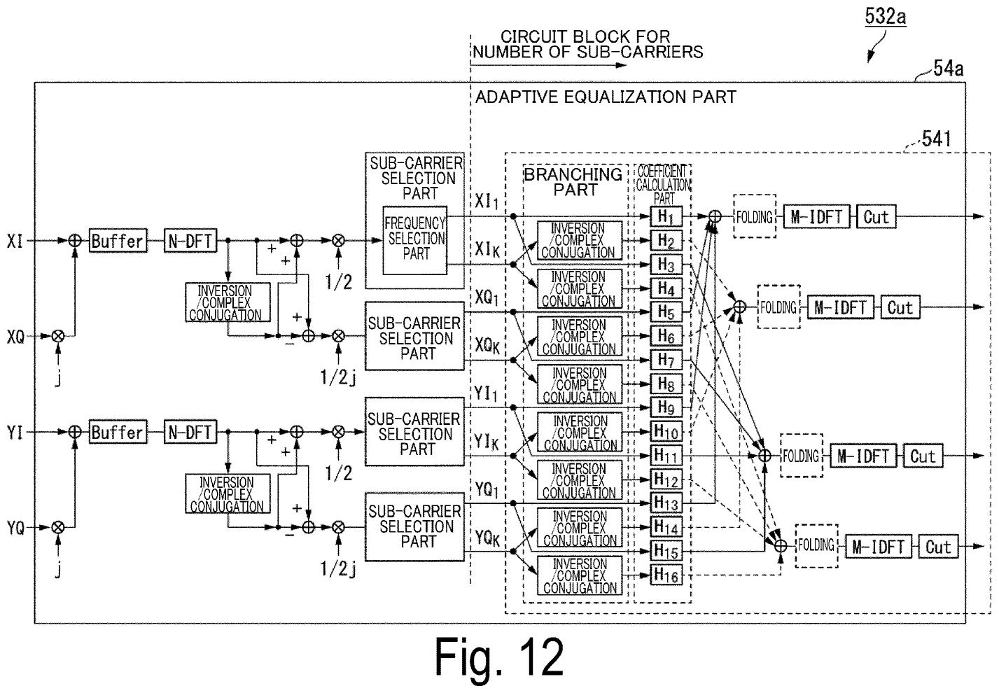

FIG. 11 is a diagram illustrating the comparison result of the number of multiplications of a configuration in the related art (for example, the configuration described in PTL 1) and the configuration of the demodulation digital signal processing part 532 including the sub-carrier selection part shown in FIG. 7. Note that, in FIG. 11, it is assumed that input sampling rate: 240 G Sample/a, symbol rate (per sub-carrier): 60 G Baud, number of sub-carriers K=2, DFT size: N, IDFT block size: M=N/(2K) (it is assumed that DFT and IDFT are calculated using fast Fourier transform (FFT) and inverse fast Fourier transform (IFFT)), overlap amount of Overlap Save method is ½ (in this case, the time response length which can be compensated is (N/(2K)×sampling interval), and the compensation performance is the same as the conventional configuration with a tap length of N/(2K)). Here, in FIG. 11, the calculation amount of the receiving side device imperfection coefficient and the dispersion compensation coefficient is excluded (only the calculation of the adaptive filter coefficient is considered).

The number of multiplications in fast Fourier transform is 4×(N/2)×log₂(N), the number of multiplications in the fast inverse Fourier transform is K×4×(N/4/K)×log₂(N/2/K), and the number of multiplications of the adaptive filter coefficients is K×16×(N/K). Under these conditions, the number of symbols which can be output from one block is N/4. Thus, the number of multiplications per symbol is 2×log₂(N)+4×log₂(N/2)+64. In the configuration in the related art, it is sufficient to consider the number of multiplications in the convolution operation per symbol. Thus, the number of taps L of the adaptive filter is 16 L.

### Second Embodiment

In a second embodiment, a configuration which can reduce the number of discrete Fourier transforms or fast Fourier transforms compared to the first embodiment will be described. Note that, in the second embodiment, a configuration of an adaptive equalization part among configurations included in a demodulation digital signal processing part is different from the first embodiment. For this reason, only differences of the first embodiment will be explained.

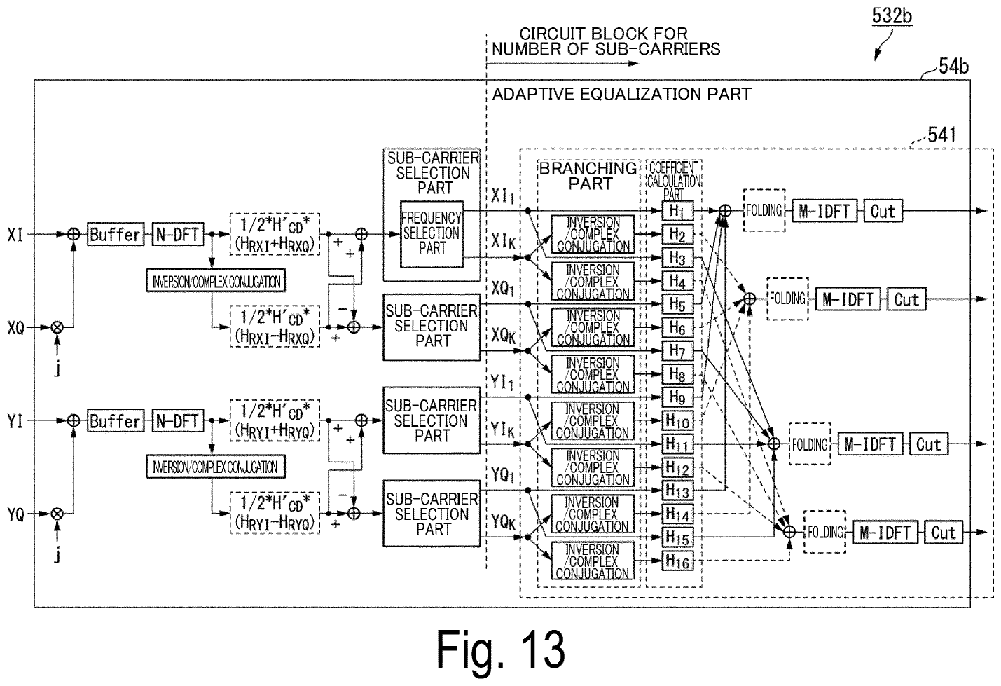

FIG. 12 is a diagram illustrating an example of a configuration of a demodulation digital signal processing part 532a in the second embodiment. Note that in FIG. 12, the configuration after a frequency/phase offset compensation part 55 which has the same configuration as the first embodiment is omitted. An adaptive equalization part 54a of the demodulation digital signal processing part 532a shown in FIG. 12 differs from the adaptive equalization part 54 in the configuration of the stage before the sub-carrier selection part. Note that the demodulation digital signal processing part 532a does not perform signal processing such as frequency characteristic compensation and chromatic dispersion compensation.

The adaptive equalization part 54a of a demodulation digital signal processing part 532 receives, as inputs, a real number component XI and an imaginary number component XQ of an X-polarized received signal converted into a digital signal using ADCs 531-1 to 531-4 and a real number component YI and an imaginary number component YQ of a Y-polarized received signal. The adaptive equalization part 54a multiplies the input imaginary number component XQ by an imaginary unit j to generate an imaginary number component jXQ. The adaptive equalization part 54a adds the real number component XI and the imaginary number component jXQ to generate an addition signal. Thus, the adaptive equalization part 54a generates the addition signal of XI+jXQ. The adaptive equalization part 54a stores the generated addition signal in a buffer.

The adaptive equalization part 54a performs N-point discrete Fourier transform or fast Fourier transform on the addition signal stored in the buffer (corresponding to “N-DFT” shown in FIG. 12). Thus, the adaptive equalization part 54a converts the X-polarized addition signal into a frequency domain signal.

The frequency domain addition signal generated using the adaptive equalization part 54a is branched into two. One branched frequency-domain addition signal is converted to a frequency-domain signal which has been subjected to inversion and has complex conjugation taken. In the following description, a frequency domain addition signal which is converted into a frequency domain signal which has been subjected to inversion and has complex conjugation taken after branching at a stage before the branching part will be referred to as a “frequency domain converted addition signal” and a frequency domain addition signal which is not converted into a frequency domain signal which has been subjected to inversion and complex conjugation after branching will be referred to as a “frequency-domain pre-conversion addition signal”.

Each of the frequency domain pre-transform addition signal and the frequency domain post-transform addition signal is branched into two and the adaptive equalization part 54a adds the frequency domain pre-transform addition signal and the frequency domain post-transform addition signal, and then multiplies the resultant signal by ½. This signal is a signal equivalent to the frequency domain signal of the real number component XI in the first embodiment. After that, the addition signal (frequency domain signal of real number component XI) multiplied by ½ is branched into four using the branching part, two of the four branched signals are input directly to the coefficient calculation part, and the remaining two signals are converted into frequency domain signals which have been subjected to inversion and has complex conjugation taken and are input to the coefficient calculation part.

Furthermore, the adaptive equalization part 54a subtracts the frequency domain post-transform addition signal from the frequency domain pre-transform addition signal, and then multiplies the subtracted signal by ½j. This signal is a signal equivalent to the frequency domain signal of the imaginary number component XQ in the first embodiment. After that, the signal multiplied by ½j (signal in the frequency domain of imaginary number component XQ) is branched into four by the branching part, two of the four branched signals are input directly to the coefficient calculation part, and the remaining two signals are converted into frequency domain signals which have been subjected to inversion and has complex conjugation taken and are input to the coefficient calculation part.

The above is the processing relating to X polarization.

Similarly, the adaptive equalization part 54a multiplies the input imaginary number component YQ by an imaginary unit j to generate an imaginary number component jYQ. The adaptive equalization part 54a adds the real number component YI and the imaginary number component jYQ. Thus, the adaptive equalization part 54a generates an addition signal of YI+jYQ. The adaptive equalization part 54a stores the generated addition signal in a buffer.

The adaptive equalization part 54a performs N-point discrete Fourier transform or fast Fourier transform on the addition signal stored in the buffer (corresponding to “N-DFT” shown in FIG. 12). Thus, the adaptive equalization part 54a converts the Y-polarized addition signal into a frequency domain signal.

The frequency domain addition signal generated using the adaptive equalization part 54a is branched into two. One branched frequency-domain addition signal is converted to a frequency-domain signal which has been subjected to inversion and has complex conjugation taken. Each of the frequency domain pre-transform addition signal and the frequency domain post-transform addition signal is branched into two and the adaptive equalization part 54a adds the frequency domain pre-transform addition signal and the frequency domain post-transform addition signal, and then multiplies the resultant signal by ½. This signal is a signal equivalent to the frequency domain signal of the real number component YI in the first embodiment. After that, the addition signal (frequency domain signal of real number component YI) multiplied by ½ is branched into four by the branching part, two of the four branched signals are input directly to the coefficient calculation part, and the remaining two signals are converted into frequency domain signals which have been subjected to inversion and has complex conjugation taken and are input to the coefficient calculation part.

Furthermore, the adaptive equalization part 54a subtracts the frequency domain post-transform addition signal from the frequency domain pre-transform addition signal, and then multiplies the subtracted signal by ½j. This signal is a signal equivalent to the frequency domain signal of the imaginary number component YQ in the first embodiment. After that, the signal multiplied by ½j (frequency domain signal of imaginary number component YQ) is branched into four by the branching part, two of the four branched signals are input directly to the coefficient calculation part, and the remaining two signals are converted into frequency domain signals which have been subjected to inversion and has complex conjugation taken and are input to the coefficient calculation part.

The above is the processing relating to Y polarization.

Note that, in the adaptive equalization part 54a, the processing after the coefficient calculation part is the same as in the first embodiment.

According to the demodulation digital signal processing part 532 in the second embodiment configured as described above, the number of discrete Fourier transforms or fast Fourier transforms can be reduced compared to the first embodiment. Specifically, the demodulation digital signal processing part 532 in the second embodiment performs discrete Fourier transform or fast Fourier transform after adding the real number component XI and the imaginary number component XQ. Thus, there is no need to perform discrete Fourier transform or fast Fourier transform on each of the real number component XI and the imaginary number component XQ. For this reason, the number of discrete Fourier transforms or fast Fourier transforms can be reduced compared to the first embodiment.

### (Modified Example of Second Embodiment)

The sub-carrier selection part included in the adaptive equalization part 54a may have any of the configurations shown in FIGS. 7 to 9.

### Third Embodiment

In the third embodiment, the configuration of the adaptive equalization part among the configurations included in the demodulation digital signal processing part is different from the second embodiment. For this reason, differences from the second embodiment will be explained.

FIG. 13 is a diagram illustrating an example of the configuration of the demodulation digital signal processing part 532b in the third embodiment. Note that, in FIG. 13, the configuration after the frequency/phase offset compensation part 55 which has the same configuration as the second embodiment is omitted. The demodulation digital signal processing part 532b includes an adaptive equalization part 54b and a frequency/phase offset compensation part 55 (omitted in FIG. 13).

The adaptive equalization part 54b multiplies the pre-conversion addition signal in the frequency domain of the X polarization by a value (½×H_{CD}*) which is the sum of the receiving side device characteristic H_{RVI} and the receiving side device characteristic H_{RYQ}.

Similarly, the adaptive equalization part 54b multiplies the converted addition signal in the frequency domain of the X polarization by the value (½×H_{CD}*) obtained by subtracting the receiving device characteristic H_{RNQ} from the receiving device characteristic H_{RNI}. The pre-conversion addition signal in the frequency domain of X polarization multiplied by ½×H_{CD}* and the post-conversion addition signal in the frequency domain of X polarization multiplied by ½×H_{CD}* are each divided into two.

The adaptive equalization part 54b performs a pre-conversion addition signal in the frequency domain of the X-polarized wave multiplied by ½×H_{CD}* and a post-conversion addition signal in the frequency domain of the X-polarized wave multiplied by ½×H_{CD}*. After that, this addition signal is input to the first stage sub-carrier selection part.

Furthermore, the adaptive equalization part 54b converts the frequency domain post-conversion addition signal of the X-polarized wave multiplied by ½×H_{CD}* to the pre-conversion addition signal in the frequency domain of the X-polarization multiplied by ½×H_{CD}*. After that, this subtracted signal is input to the second stage sub-carrier selection part. The above is the processing relating to X polarization.

The adaptive equalization part 54b multiplies the pre-conversion addition signal in the frequency domain of Y polarization by a value (½×H_{CD}*) which is the sum of the receiving side device characteristic H_{RYI} and the receiving side device characteristic H_{RYQ}. Similarly, the adaptive equalization part 54b multiplies the converted addition signal in the frequency domain of Y polarization by the value (½×H_{CD}*) obtained by subtracting the receiving device characteristic H_{RYQ} from the receiving device characteristic H_{RYI}. Each of the pre-conversion addition signal in the frequency domain of Y polarization multiplied by ½×H_{CD}* and the post-conversion addition signal in the frequency domain of Y polarization multiplied by ½×H_{CD}* is divided into two.

The adaptive equalization part 54b adds the pre-conversion addition signal in the frequency domain of Y polarization multiplied by ½×H_{CD}* and the converted addition signal in the frequency domain of Y polarization multiplied by ½×H_{CD}*. After that, this addition signal is input to the third stage sub-carrier selection part.

Furthermore, the adaptive equalization part 54b subtracts the pre-conversion addition signal in the frequency domain of Y polarization multiplied by ½×H_{CD}* from the post-conversion addition signal in the frequency domain of Y polarization multiplied by ½×H_{CD}*. After that, this subtracted signal is input to the fourth stage sub-carrier selection part.

The above is the processing relating to Y polarization.

Note that, in the adaptive equalization part 54b, the processing after the sub-carrier selection part is the same as in the second embodiment.

According to the demodulation digital signal processing part 532b in the third embodiment configured as above, this embodiment is different from the second embodiment and the number of discrete Fourier transforms or fast Fourier transforms can be reduced compared to the first embodiment. Note that, in the configuration of the demodulation digital signal processing part 532b in the third embodiment, it is possible to reduce the bit precision if H_{RVI}-H_{RNQ} and H_{RYI}-H_{RYQ} are small.

### (Modified Example of Third Embodiment)

The sub-carrier selection part included in the adaptive equalization part 54b may have the configuration shown in FIG. 9.

### (Modified Example Common to First to Third Embodiments)

In each of the embodiments described above, a configuration in which wavelength division multiplexing is performed in addition to sub-carrier multiplexing and polarization division multiplexing may be combined. The following configuration is different from the digital coherent optical transmission system 1 shown in FIG. 1 when configured in this way.

The transmitter 10 further includes transmission parts 100 as many as the number of wavelength division multiplexing (WDM) channels. For example, when the number of WDM channels is 10, the transmitter 10 will have 10 transmission parts 100. Each of the transmission parts 100 outputs optical signals of different wavelengths. A WDM multiplexer, an optical fiber transmission line 30, and a WDM demultiplexer are provided between the transmitter 10 and the receiver 50. The WDM multiplexer multiplexes the optical signals output from each of the transmission parts 100 and outputs the multiplexed optical signals to the optical fiber transmission line 30. The WDM demultiplexer demultiplexes the optical signal transmitted through the optical fiber transmission line 30 according to the wavelength thereof. The receiver 50 further includes receiving parts 500 for the number of WDM channels. For example, when the number of WDM channels is 10, the receiver 50 will have 10 receiving parts 500. Each of the receiving parts 500 receives the optical signal demultiplexed by the WDM demultiplexer 40. The wavelengths of the optical signals received by each of the receiving parts 500 are different. The processing performed in the receiving part 500 is similar to the processing described above.

In each of the above embodiments, when N=K×M, there is no need to perform the folding process in the adaptive equalization parts 54, 54a, and 54b.

Some of the functional parts of the receiver 50 in the embodiment described above may be realized using a computer. In that case, a program for realizing this function may be recorded on a computer-readable recording medium and the program recorded on the recording medium may be read into a computer system and executed. Note that the “computer system” mentioned herein includes hardware such as an OS and peripheral devices.

Also, a “computer-readable recording medium” refers to a storage device such as a flexible disk, a magneto-optical disk, a read only memory (ROM), a portable medium such as a CD-ROM, or a hard disk built into a computer system. Furthermore, the term “computer-readable recording medium” may also include a recording medium which dynamically stores a program for a short period of time such as a communication line when transmitting a program via a network such as the Internet or a communication line such as a telephone line and a storage medium which retains programs for a certain period of time such as volatile memory inside a computer system which is a server or client in that case. Furthermore, the program may be for realizing some of the functions described above. In addition, the program may be a program which can realize the above-mentioned functions in combination with a program already recorded in the computer system and the program may be realized using a programmable logic device such as a field-programmable gate array (FPGA).

Although the embodiments of the present invention have been described above in detail with reference to the drawings, the specific configuration is not limited to these embodiments and includes designs within the scope of the gist of the present invention.

### INDUSTRIAL APPLICABILITY

The present invention is applicable to the technique of receiving the sub-carrier multiplexed polarization multiplexed signal in digital coherent optical transmission.

### REFERENCE SIGNS LIST

1 Digital coherent optical transmission system
10 Transmitter
30 Optical fiber transmission path
31 Optical amplifier
50 Receiver
54, 54a, 54b Adaptive equalization part
55 Frequency/phase offset compensation part
56 Front end correction and chromatic dispersion estimation part
100 Transmission part
110 Digital signal processing part
111 Encoding part
112 Mapping part
113 Training signal insertion part
114 Frequency conversion part
115 Waveform shaping part
116 Sub-carrier multiplexing part
117 Pre-equalization part
118-1 to 118-4 Digital-analog conversion part
119 Signal generation part
120 Modulator driver
121-1 to 121-4 Amplifier
130 Light source
140 Integration module
141-1, 141-2 IQ modulator
142 Polarization combination part
500 Receiving part
510 Local oscillation light source
520 Optical front end
521 Polarization separation part
522-1, 522-2 Optical 90-degree hybrid coupler
523-1 to 523-4 BPD
524-1 to 524-4 Amplifier
530 Digital signal processing part
531-1 to 531-4 Analog-to-digital converter
532, 532a, 532b Demodulation digital signal processing part
533 Demapping part
534 Decoding part

1. A signal processing method, comprising:
converting a real number component and an imaginary number component of each polarization of a sub-carrier-multiplexed and polarization-multiplexed received signal into a frequency domain signal;
selecting a frequency domain signal corresponding to a sub-carrier;
receiving, as input signals, a frequency domain signal of the real number component and a frequency domain signal of the imaginary number component of each polarization of each selected sub-carrier and a frequency domain signal after conversion obtained by subjecting a center frequency of the selected sub-carrier on a frequency axis of the frequency domain signal of the real number component and the frequency domain signal of the imaginary number component of each polarized wave of sub-carriers forming a pair of sub-carriers which are line-symmetrical with respect to a direct current (DC) component to frequency inversion and taking complex conjugation;
performing, for each sub-carrier and polarization, a first equalization process of multiplying each of the frequency domain signal of the real number component and the frequency domain signal of the imaginary number component of each polarization included in the input signal by a complex transfer function and then adding them and performing inverse conversion on them from a frequency domain signal into a time domain signal and a second equalization process of multiplying each of the frequency domain signal after the conversion of the real number component and the frequency domain signal after the conversion of the imaginary number component of each polarization included in the input signal by a complex transfer function and then adding them and performing inverse conversion on them from a frequency domain signal into a time domain signal; and
performing, for each sub-carrier and each polarization, a phase rotation for frequency offset compensation on the time domain signal converted using the first equalization process to generate a first addition signal, performing a phase rotation opposite to the phase rotation for frequency offset compensation on the time domain signal converted using the second equalization process to generate a second addition signal, and adding or subtracting a transmission data bias correction signal to or from a signal obtained by adding the first addition signal and the second addition signal.

2. A signal processing method, comprising:
performing an imaginary unit multiplication process in which an imaginary number component of each polarization of a sub-carrier-multiplexed and polarization-multiplexed received signal is multiplied by an imaginary unit j and then performing an addition process of adding an imaginary number component multiplied by the imaginary unit j and a real number component of each polarization of the sub-carrier-multiplexed and polarization-multiplexed received signal;
converting a signal after addition processing of the imaginary number component multiplied by the imaginary unit j and the real number component into a frequency domain signal;
receiving, as inputs, a calculated frequency domain signal after calculation is performed on the frequency domain signal of each polarization and a calculated frequency domain signal after conversion after performing calculation on the frequency domain signal after conversion obtained by subjecting the frequency domain signal of each polarization to frequency inversion on the frequency axis and taking complex conjugation and selecting a frequency domain signal corresponding to a sub-carrier;
receiving, as an input signal, the frequency domain signal corresponding to the sub-carrier selected in the receiving, either as it is or with compensation;
performing, for each sub-carrier and polarization, a first equalization process of multiplying each of the calculated frequency domain signal of the real number component and the calculated frequency domain signal of the imaginary number component of each polarization included in the input signal by a complex transfer function and then adding them and performing inverse conversion on them from a frequency domain signal into a time domain signal and a second equalization process of multiplying each of the calculated frequency domain signal after converting the real number component and the calculated frequency domain signal after converting the imaginary number component of each polarization included in the input signal by a complex transfer function and then adding them and performing inverse conversion on them from a frequency domain signal to a time domain signal; and
performing, for each sub-carrier and each polarization, a phase rotation for frequency offset compensation on a time domain signal converted using the first equalization process to generate a first addition signal, performing a phase rotation opposite to the phase rotation for frequency offset compensation on the time domain signal converted using the second equalization process to generate a second addition signal, and adding or subtracting a transmission data bias correction signal to or from a signal obtained by adding the first addition signal and the second addition signal.

3. The signal processing method according to claim 2, wherein a first signal process of branching the frequency domain signal into a first path and a second path, adding the frequency domain signal branched to the first path and the frequency domain signal branched to the second path and subjected to frequency inversion and complex conjugation, and then multiplying it by ½ and a second signal processing of subtracting the frequency-domain signal branched to the second path and frequency-inverted and complex-conjugated from the frequency-domain signal branched to the first path and then multiplying it by ½j are performed for each polarization and then selection in the receiving is performed.

4. The signal processing method according to claim 2, wherein a first signal process of branching the frequency domain signal into a first path and a second path and adding a frequency domain signal after compensation for frequency characteristics and chromatic dispersion compensation for the frequency domain signal branched to the first path and a frequency domain signal after being branched to the second path, subjected to frequency inversion and complex conjugation, and after frequency characteristic compensation and chromatic dispersion compensation are performed and a second signal process of subtracting a frequency domain signal after being branched to the second path, subjected to frequency inversion and complex conjugation, and after frequency characteristic compensation and chromatic dispersion compensation are performed from a frequency domain signal after compensation for frequency characteristics and chromatic dispersion compensation for the frequency domain signal branched to the first path are performed for each polarization and then selection in the receiving is performed.

5. The signal processing method according to claim 1, wherein, in the receiving,
after compensating for the frequency characteristics, the frequency domain signal corresponding to the sub-carrier is selected and dispersion compensation for each sub-carrier is performed,
after selecting a frequency domain signal corresponding to a sub-carrier, compensation for the frequency characteristics and dispersion compensation for each sub-carrier are performed, or
after performing frequency characteristic compensation and dispersion compensation for each sub-carrier, selecting a frequency domain signal corresponding to the sub-carrier is performed.

6. A signal processing device, comprising:
a frequency converter configured to convert a real number component and an imaginary number component of each polarization of a sub-carrier-multiplexed and polarization-multiplexed received signal into a frequency domain signal;
a sub-carrier selector configured to select a frequency domain signal corresponding to a sub-carrier;
a signal inputter configured to receive, as input signals, a frequency domain signal of the real number component and a frequency domain signal of the imaginary number component of each polarization of each selected sub-carrier and a frequency domain signal after conversion obtained by subjecting a center frequency of the selected sub-carrier on a frequency axis of the frequency domain signal of the real number component and the frequency domain signal of the imaginary number component of each polarized wave of sub-carriers forming a pair of sub-carriers which are line-symmetrical with respect to a direct current (DC) component to frequency inversion and taking complex conjugation;
an equalizer configured to perform, for each sub-carrier and polarization, a first equalization process of multiplying each of the frequency domain signal of the real number component and the frequency domain signal of the imaginary number component of each polarization included in the input signal by a complex transfer function and then adding them and performing inverse conversion on them from a frequency domain signal into a time domain signal and a second equalization process of multiplying each of the frequency domain signal after the conversion of the real number component and the frequency domain signal after the conversion of the imaginary number component of each polarization included in the input signal by a complex transfer function and then adding them and performing inverse conversion on them from a frequency domain signal into a time domain signal; and
a compensator configured to perform, for each sub-carrier and each polarization, a phase rotation for frequency offset compensation on the time domain signal converted using the first equalization process to generate a first addition signal, performs a phase rotation opposite to the phase rotation for frequency offset compensation on the time domain signal converted using the second equalization process to generate a second addition signal, and adds or subtracts a transmission data bias correction signal to or from a signal obtained by adding the first addition signal and the second addition signal.

7. (canceled)

8. (canceled)
